(19) United States
(12) Patent Application Publication
(10) Pub. No.: US 2026/0015042 A1
(43) Pub. Date: Jan. 15, 2026

(54) FRONT BODY STRUCTURE OF VEHICLE

(71) Applicants: Hyundai Motor Company, Seoul (KR); Kia Corporation, Seoul (KR)

(72) Inventors: Hong-Soek YOEN, Hwaseong-Si (KR); Sun-Ki CHOI, Hwaseong-Si (KR); Byeong-Cheon LEE, Hwaseong-Si (KR)

(73) Assignees: Hyundai Motor Company, Seoul (KR); Kia Corporation, Seoul (KR)

(21) Appl. No.: 18/952,751

(22) Filed: Nov. 19, 2024

(30) Foreign Application Priority Data
Jul. 15, 2024 (KR) 10-2024-0093027

(51) Int. Cl. B62D 25/08; B60R 5/02; B62D 25/16; B62D 27/00

(52) U.S. Cl. CPC B62D 25/087; B60R 5/02; B62D 25/16; B62D 27/00

(57) ABSTRACT

A front body structure of a vehicle, which is capable of inducing an evasive behavior of the vehicle in the event of a small overlap collision and reinforcing the rigidity of a vehicle body, may include a pair of front side members disposed in a longitudinal direction of the vehicle and spaced apart from each other in a width direction of the vehicle, a front end module upper member disposed in the width direction of the vehicle and including both end portions located above the front side members, a frunk support bar disposed in the width direction of the vehicle behind the front end module upper member, and a frunk side bar connecting the front end module upper member to the frunk support bar.

### CROSS-REFERENCE TO RELATED APPLICATION

The present application claims priority to Korean Patent Application No. 10-2024-0093027, filed on Jul. 15, 2024, the entire contents of which is incorporated herein for all purposes by this reference.

### BACKGROUND OF THE PRESENT DISCLOSURE

### Field of the Present Disclosure

The present disclosure relates to a front body structure of a vehicle, which is capable of inducing an evasive behavior of the vehicle in the event of a small overlap collision and reinforcing the rigidity of a vehicle body.

### Description of Related Art

A structure for supporting a vehicle body in the event of a collision of a vehicle is applied to the front of the vehicle.

A front body structure of the vehicle requires a structure for supporting a collision load of the vehicle in the event of a collision of the vehicle and transmitting the collision load to the rear part of the vehicle to protect occupants of the vehicle.

In the front collision of the vehicle, in reality, a small overlap collision in which a portion of a front surface of the vehicle collides occurs more often than a frontal collision, so recently, the front body structure of the vehicle has been developed to respond to the small overlap collision.

In the event of the small overlap collision, most of the collision load is transmitted to only one side of left and right sides of the vehicle, such that the vehicle makes an evasive behavior or a turning behavior in the event of the small overlap collision. During a small overlap collision test of the vehicle, a portion of the front surface of the vehicle collides with a barrier to perform the test. For example, when a left front surface of the vehicle collides with the barrier in a small overlap collision manner, the vehicle makes an evasive behavior in which the vehicle moves to the right or a rotation behavior in which the vehicle rotates counterclockwise. During the evasive behavior, an A-pillar of the vehicle evades a collision load because it is not caught on the barrier, but during the rotation behavior, the A-pillar is caught on the barrier, and the collision load tends to be transmitted to a body structure after the A-pillar. Therefore, to respond to the small overlap collision, it is advantageous for the vehicle to have a body structure which may perform the evasive behavior.

Typically, as shown in FIG. 1, a space called an “engine compartment” is formed in the front of the vehicle, and a pair of front side members 111 disposed in a longitudinal direction of the vehicle are provided at both sides of the engine compartment, and a front back beam 112 disposed in a width direction of the vehicle is connected to front ends of the front side members 111.

However, since the pair of front side members 111 spaced apart from each other in the width direction of the vehicle do not have a member connected in the width direction of the vehicle between the front back beam 112 and a dash panel, connection rigidity between the front side members 111 is insufficient, and thus there are problems that the rigidity of the front body of the vehicle is lowered and an evasive behavior cannot be induced in the event of a small overlap collision.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a front body structure of a vehicle, which is configured for reinforcing the rigidity of a vehicle body and inducing an evasive behavior in the event of a small overlap collision by adopting a structure that connects front side members in a width direction of the vehicle.

A front body structure of a vehicle according to an exemplary embodiment of the present disclosure includes a pair of front side members disposed in a longitudinal direction of the vehicle and disposed at an interval therebetween in a width direction of the vehicle, a front end module upper member disposed in the width direction of the vehicle and including first and second end portions each located above the front side members, a frunk support bar disposed behind the front end module upper member in the width direction of the vehicle, and a frunk side bar connecting the front end module upper member to the frunk support bar.

The frunk side bar includes a front end portion connected to a side end portion of the front end module upper member and a rear end portion connected to a side end portion of the frunk support bar.

The frunk side bar is disposed perpendicular to a middle portion of the front end module upper member and the frunk support bar and parallel to the front side member.

The front body structure further includes a front end module side rear member located on a rear surface of a front end module of the vehicle, disposed in a height direction of the vehicle, and connected to a lower end portion of an upper surface of a corresponding front side member among the pair of front side members, wherein the front end module upper member is connected to the front end module side rear member.

The front end module upper member includes a front end module upper front member forming an upper surface and a front surface of the front end module upper member, and a front end module upper rear member forming a bottom surface and a rear surface of the front end module upper member and connected to a lower side of the front end module upper front member, and a side end portion of the front end module upper front member is connected to the front end module side rear member.

The front body structure further includes a frunk side bar mounting member fastening an internal surface of a rear end side of the frunk side bar to a fender apron member of the vehicle.

The front end module upper member, the frunk support bar, and the frunk side bar form a quadrangular first frame structure parallel to the ground, and the front end module side rear member and the frunk side bar mounting member form a quadrangular second frame structure disposed perpendicular to the ground together with the frunk side bar and the front side member in the longitudinal direction of the vehicle.

The first frame structure and the second frame structure share the frunk side bar.

The front end module upper member is formed so that an area located between first and second end portions thereof is located at a front of the vehicle further than end portions connected to the frunk side bar.

The front body structure further includes a frunk support bar connecting bracket connected to a rear end portion of the frunk side bar and connected to a side end portion of the frunk support bar.

The front body structure further includes a slide away bar disposed between a rear of the front end module upper member and a front of the frunk support bar and including first and second end portions each connected to the front side member.

The front body structure further includes a slide away bar bracket connected to the front side member and connected to the side end portion of the slide away bar.

The front end module upper member, the frunk support bar, and the slide away bar are in parallel to each other and disposed perpendicular to the front side member.

The front body structure further includes a crossbar disposed behind the frunk support bar and including first and second end portions connected to a fender apron member of the vehicle.

The front body structure further includes a front back beam disposed at front end portions of the front side members in the width direction of the vehicle and connected to the front end portions of the front side members to connect the front end portions of the pair of front side members.

The frunk support bar supports a bottom surface of a frunk that stores items therein.

According to the front body structure of the vehicle of the present disclosure including the above configuration, it is possible to increase the rigidity of the vehicle body by connecting the pair of front side members in the width direction of the vehicle using the structure that supports the frunk to form the front structure of the vehicle in a box shape. It is possible to increase the rigidity of the vehicle body by forming the first frame structure and the second frame structure, which share the front side bar, parallel to or perpendicular to the ground.

As described above, since the rigidity of the vehicle body is increased and the pair of front side members spaced apart from each other are connected to the front end module upper member, the frunk support bar, the slide away bar, and the crossbar, in the event of the small overlap collision, the collision load input into one front side member may be transferred to the other front side member.

Therefore, in the event of the small overlap collision, it is possible to induce the evasive behavior and prevent the deformation to the rear of the pillar, reducing the occupant's injury.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view showing a front body structure of a vehicle according to the related art.

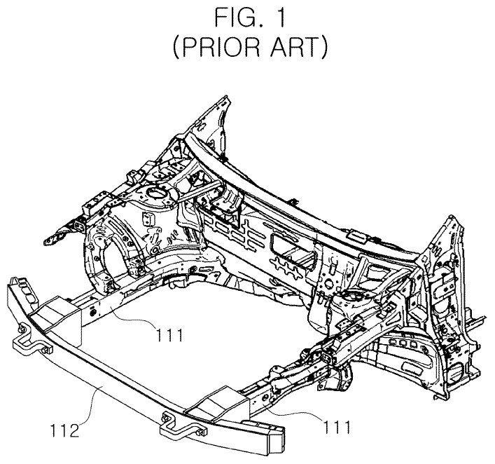

FIG. 2 is a perspective view showing a front body structure of a vehicle according to an exemplary embodiment of the present disclosure.

FIG. 3 is a plan view showing the front body structure of the vehicle according to an exemplary embodiment of the present disclosure.

FIG. 4 is a side view showing the front body structure of the vehicle according to an exemplary embodiment of the present disclosure.

FIG. 5 is a perspective view showing main portions of the front body structure of the vehicle according to an exemplary embodiment of the present disclosure.

FIG. 6 is an exploded perspective view showing the main portions of the front body structure of the vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a front body structure of a vehicle according to an exemplary embodiment of the present disclosure will be described in detail with reference to the accompanying drawings.

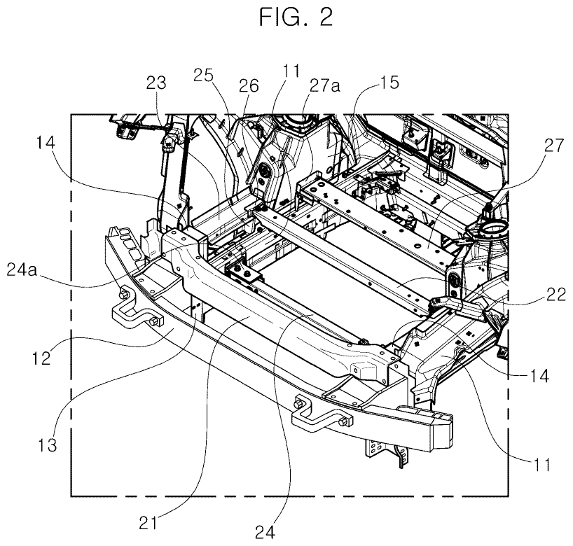

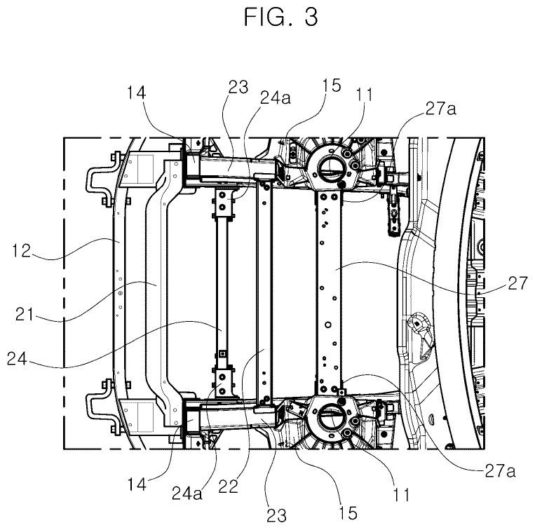

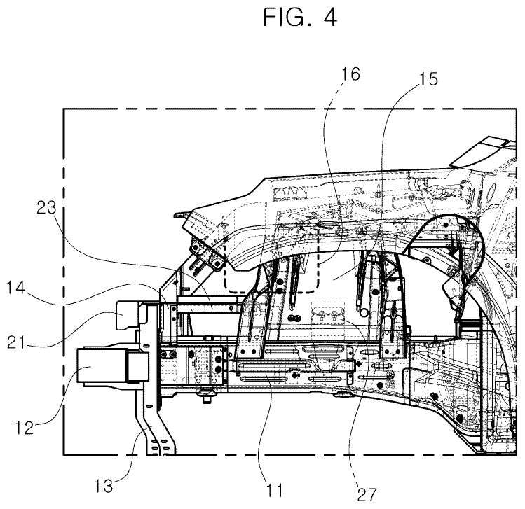

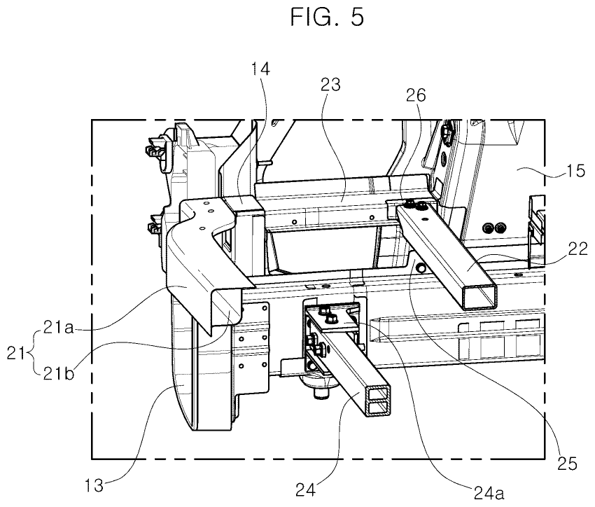

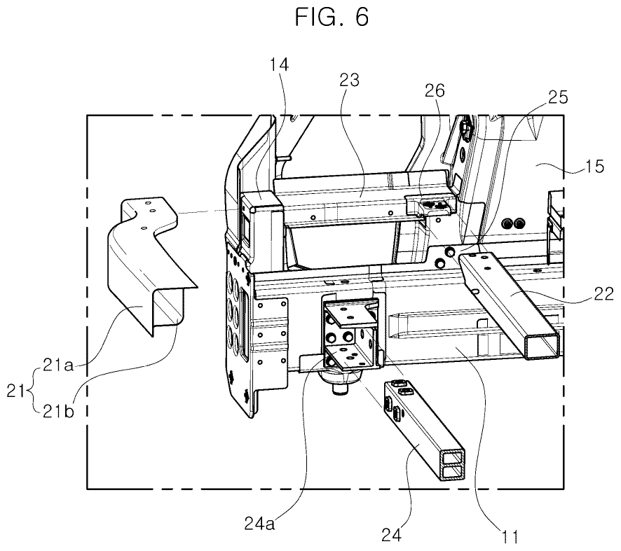

As shown in FIGS. 2, 3, 4, 5 and 6, the front body structure of the vehicle according to an exemplary embodiment of the present disclosure includes a pair of front side members 11 disposed in a longitudinal direction of the vehicle and spaced apart from each other in a width direction of the vehicle, a front end module upper member 21 disposed in the width direction of the vehicle and including both end portions located above the front side members 11, a frunk support bar 22 disposed in the width direction of the vehicle behind the front end module upper member 21, and a frunk side bar 23 connecting the front end module upper member 21 to the frunk support bar 22.

Typically, the so-called “engine compartment” located at the front of the vehicle has front side members 11 disposed at both sides in the longitudinal direction of the vehicle to form a basic structure of a front portion of the vehicle.

The front side members 11 are disposed at both sides of the engine compartment in the longitudinal direction of the vehicle. A pair of front side members 11 are provided at an interval in the width direction of the vehicle and connect a front back beam 12 located at a front end portion of the vehicle and provided with a bumper to a dash panel that partitions the engine compartment and a cabin to form the basic structure of the front portion of the vehicle.

Meanwhile, recently, as the spread of eco-friendly vehicles such as electric vehicles that do not install an engine is expanding, a frunk 16 which may store various items in the engine compartment is provided in the engine compartment of the electric vehicle using a space left due to the engine not provided. Since the engine is not provided in the electric vehicle, the engine compartment is sometimes called a power electric (PE) room instead.

To support a bottom surface of the frunk 16 of the electric vehicle, the frunk support bar 22 is provided in the engine compartment, and using the frunk support bar 22, the rigidity of the front body of the vehicle is increased.

As described above, the pair of front side members 11 are provided and are disposed in the longitudinal direction of the vehicle in the engine compartment of the vehicle, and the front side members 11 are disposed at an interval in the width direction of the vehicle.

A front end portion of the front side member 11 is connected to the front back beam 12 of the vehicle. The front back beam 12 is disposed in the width direction of the vehicle and is connected to the front end portion of the front side member 11 to connect the pair of the front side members 11. Furthermore, a front bumper of the vehicle is mounted on the front back beam 12.

A front end module 13 on which a radiator and the like are mounted is mounted behind the front back beam 12 of the front side member 11.

In an exemplary embodiment of the present disclosure, to reinforce the rigidity of the front of the vehicle in addition to the front side members 11, a quadrangular first frame structure including the frunk support bar 22 supporting the frunk 16 is formed above the front side member 11.

To the present end, the front body structure includes the front end module upper member 21 disposed in the width direction of the vehicle and including both end portions located above the front side member 11, the frunk support bar 22 disposed in the width direction of the vehicle behind the front end module upper member 21, and the frunk side bar 23 connecting the front end module upper member 21 to the frunk support bar 22.

The front end module upper member 21 is located above the front side member 11 on a rear surface of the front end module 13. The front end module upper member 21 is disposed in the width direction of the vehicle. The front end module upper member 21 is formed by fastening a front end module upper front member 21a to a front end module upper rear member 21b. The front end module upper front member 21a forms an upper surface and a front surface of the front end module upper member 21, and the front end module upper rear member 21b forms a bottom surface and a rear surface of the front end module upper member 21. The front end module upper rear member 21b is connected to the lower side of the front end module upper front member 21a to form the front end module upper member 21.

Meanwhile, to avoid interference with the front end module 13, the front end module upper member 21 is formed so that an area located between both end portions thereof is located at the front of the vehicle further than both the both end portions connected to the frunk side bar 23. Therefore, the front end module upper member 21 is formed in a curved shape to fasten an area adjacent to the side end portion thereof to the front side member 11, but most of the middle section is disposed parallel to the frunk support bar 22.

The frunk support bar 22 is disposed in the width direction of the vehicle behind the front end module upper member 21. The frunk support bar 22 is disposed parallel to the front end module upper member 21.

The frunk side bar 23 is disposed in the longitudinal direction of the vehicle to connect the side end portion of the front end module upper member 21 to the side end portion of the frunk support bar 22. A rear end portion of the frunk side bar 23 is connected to a frunk support bar connecting bracket 26 connected to the side end portion of the frunk support bar 22 to be connected to the frunk support bar 22.

The frunk side bar 23 is disposed perpendicular to the middle portion of the front end module upper member 21 and the frunk support bar 22. Since the frunk side bar 23 is disposed parallel to the front side member 11 in the width direction of the vehicle, the frunk side bar 23 is disposed perpendicular to the front end module upper member 21 and the frunk support bar 22. A front end portion of the frunk side var 23 is connected to the side end portion of the front end module upper member 21 and the rear end portion of the frunk side var 23 is connected to the side end portion of the frunk support bar 22. Therefore, the front end module upper member 21, the frunk support bar 22, and the frunk side bar 23 form the quadrangular first frame structure parallel to the ground.

Since the front end module upper member 21, the frunk support bar 22, and the frunk side bar 23 are located above the front side member 11, a front end module side rear member 14 and a frunk side bar mounting member 25 are provided to connect the front end module upper member 21, the frunk support bar 22, and the frunk side bar 23 to the front side member 11.

The front end module side rear member 14 is located on the rear surface of the front end module 13 of the vehicle, disposed in a height direction of the vehicle, and connected to a lower end portion of an upper surface of a corresponding front side member among the pair of front side members 11. The front end module upper member 21 is connected to an upper end portion of the front end module side rear member 14 formed perpendicular to the ground on the upper surface of the front side member 11 in the longitudinal direction of the vehicle.

The side end portion of the front end module upper front member 21a is connected to the front end module side rear member 14 so that the front end module upper member 21 is connected to the front end module side rear member 14.

The frunk side bar mounting member 25 is disposed in the height direction of the vehicle. The frunk side bar mounting member 25 is connected to an internal side of the rear end side of the frunk side bar 23 and a fender apron member 15 of the vehicle.

The front end module side rear member 14 and the frunk side bar mounting member 25 form a quadrangular second frame structure disposed perpendicular to the ground together with the frunk side bar 23 and the front side member 11 in the longitudinal direction of the vehicle. The first frame structure and the second frame structure share the frunk side bar 23 to form a rectangular structure which is parallel or perpendicular to the ground, reinforcing the rigidity of the front of the vehicle.

The slide away bar 24 is additionally disposed between the front end module upper member 21 and the frunk support bar 22 to connect the front side member 11. The slide away bar 24 is disposed parallel to the front end module upper member 21 and the frunk support bar 22, disposed between the rear of the front end module upper member 21 and the front of the frunk support bar 22, and has both end portions each connected to the front side member 11. Therefore, the slide away bar 24 connects the front side member 11 under the first frame structure.

The slide away bar 24 is connected to the front side member 11 through the slide away bar bracket 24a. The slide away bar bracket 24a is connected to the front side member 11 and the side end portion of the slide away bar 24 is connected so that the slide away bar 24 is connected to the front side member 11.

Furthermore, a crossbar 27 is disposed behind the frunk support bar 22. The crossbar 27 has both end portions connected to the fender apron member 15 of the vehicle via a cross bar bracket 27a.

The crossbar 27 is disposed behind the frunk support bar 22 in the width direction of the vehicle to form a structure that connects the fender apron member 15 of the vehicle, reinforcing the rigidity behind the frunk support bar 22 in the width direction of the vehicle.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A front body structure of a vehicle, the front body structure comprising:
a pair of front side members disposed in a longitudinal direction of the vehicle and disposed at an interval therebetween in a width direction of the vehicle;
a front end module upper member disposed in the width direction of the vehicle and including first and second end portions each located above the front side members;
a frunk support bar disposed behind the front end module upper member in the width direction of the vehicle; and
a frunk side bar connecting the front end module upper member to the frunk support bar.

2. The front body structure of claim 1,
wherein the front end module upper member, the frunk support bar, and the frunk side bar form a quadrangular first frame structure parallel to the ground, and
wherein a front end module side rear member and a frunk side bar mounting member form a quadrangular second frame structure disposed perpendicular to the ground together with the front side bar and the front side member in the longitudinal direction of the vehicle.

3. The front body structure of claim 2, wherein the front end module side rear member and the frunk side bar mounting member are provided to connect the front end module upper member, the frunk support bar, and the frunk side bar to the front side members.

4. The front body structure of claim 2, wherein the front end module side rear member is located on a rear surface of a front end module of the vehicle, disposed in a height direction of the vehicle, and connected to a lower end portion of an upper surface of a corresponding front side member among the pair of front side members.

5. The front body structure of claim 4, wherein the front end module upper member is connected to an upper end portion of the front end module side rear member formed perpendicular to the ground on the upper surface of the corresponding front side member in the longitudinal direction of the vehicle.

6. The front body structure of claim 2, wherein the frunk side bar mounting member connects an internal surface of a rear end side of the frunk side bar to a fender apron member of the vehicle.

7. The front body structure of claim 2, wherein the frunk side bar is disposed perpendicular to a middle portion of the front end module upper member and the frunk support bar and parallel to the front side members.

8. The front body structure of claim 1, further including:
a front end module side rear member located on a rear surface of a front end module of the vehicle, disposed in a height direction of the vehicle, and connected to a lower end portion of an upper surface of a corresponding front side member among the pair of front side members,
wherein the front end module upper member is connected to the front end module side rear member.

9. The front body structure of claim 8,
wherein the front end module upper member includes:
a front end module upper front member forming an upper surface and a front surface of the front end module upper member; and
a front end module upper rear member forming a bottom surface and a rear surface of the front end module upper member and connected to a lower side of the front end module upper front member, and
wherein a side end portion of the front end module upper front member is connected to the front end module side rear member.

10. The front body structure of claim 8, further including a frunk side bar mounting member fastening an internal surface of a rear end side of the frunk side bar to a fender apron member of the vehicle.

11. The front body structure of claim 2, wherein the first frame structure and the second frame structure share the frunk side bar.

12. The front body structure of claim 1, wherein the front end module upper member is formed so that an area located between first and second end portions of the front end module upper member is located at a front of the vehicle further than the first and second end portions connected to the frunk side bar.

13. The front body structure of claim 1, further including a frunk support bar connecting bracket connected to a rear end portion of the frunk side bar and connected to a side end portion of the frunk support bar.

14. The front body structure of claim 1, further including a slide away bar disposed between a rear of the front end module upper member and a front of the frunk support bar and including first and second end portions each connected to the front side members.

15. The front body structure of claim 14, further including a slide away bar bracket connected to the front side members and connected to a side end portion of the slide away bar.

16. The front body structure of claim 14, wherein the front end module upper member, the frunk support bar, and the slide away bar are in parallel to each other and disposed perpendicular to the front side members.

17. The front body structure of claim 1, further including a crossbar disposed behind the frunk support bar and including first and second end portions connected to a fender apron member of the vehicle.

18. The front body structure of claim 1, further including a front back beam disposed at front end portions of the front side members in the width direction of the vehicle and connected to the front end portions of the front side members to connect the front end portions of the pair of front side members.

19. The front body structure of claim 1, wherein the frunk support bar supports a bottom surface of a frunk for storing items therein.
